(19) United States
(12) Patent Application Publication
(10) Pub. No.: US 2024/0240026 A1
(43) Pub. Date: Jul. 18, 2024

(54) Pulverulent Acetylene Black Material, Process for Its Production, and Compositions, Manufactured Articles and Uses Thereof

(71) Applicant: Orion Engineered Carbons IP GmbH & Co. KG, Monheim (DE)

(72) Inventors: Ralf Bergsträsser, Elsdorf (DE); Helmut Kriesch, Mechernich (DE); Wei Wei, Brühl (DE); Ainhoa Noguera, Köln (DE); Michael Rohde, Köln (DE)

(21) Appl. No.: 18/561,816

(22) PCT Filed: May 17, 2022
(86) PCT No.: PCT/EP2022/063297

§ 371 Date: Nov. 17, 2023

(30) Foreign Application Priority Data
May 18, 2021 (EP) 21174348.9

(51) Int. Cl. C09C 1/60; H01M 4/62

(52) U.S. Cl. CPC C09C 1/60; H01M 4/625; C01P 2006/10; C01P 2006/12; C01P 2006/19; C01P 2006/40; C01P 2006/80

(57) ABSTRACT

A process is provided for producing a pulverulent acetylene black material including (a) providing an initial acetylene black, (b) densifying the provided initial acetylene black to form a densified acetylene black, and (c) pulverizing the densified acetylene black to form the pulverulent acetylene black material. The pulverulent acetylene black material obtainable by this process exhibits inter alia enhanced dispersibility and yields dispersions that show improved stability over time rendering them useful as conductive or antistatic agent, reinforcing filler and/or coloring agent in compositions for various applications such electrodes and other components of energy storage and/or conversion devices, plastic articles, coatings, paints or inks.

### CROSS-REFERENCE TO RELATED APPLICATIONS

This application is the United States national phase of International Application No. PCT/EP2022/063297 filed May 17, 2022, and claims priority to European Patent Application No. 21174348.9 filed May 18, 2021, the disclosures of which are hereby incorporated by reference in their entireties.

### BACKGROUND OF THE INVENTION

### Field of the Invention

The present invention relates to a process for producing a pulverulent acetylene black material, the pulverulent acetylene black material obtainable thereby and compositions comprising the same as well as articles made thereof, and uses and applications of the pulverulent acetylene black material, e.g., for the production of electrodes or other components of energy storage or conversion devices, rubber or plastic articles.

### Description of Related Art

Acetylene black is a particular type of carbon black, which is obtainable by thermal decomposition of acetylene gas or acetylene-containing hydrocarbon feedstocks forming colloidal carbon black particles and hydrogen at high temperatures. Acetylene black has unique properties, which distinguish it from other types of carbon black such as furnace blacks. Thus, due to the production process including a clean feedstock and requiring no oxidant, acetylene black is generally very pure, has a relatively high structure and degree of graphitization compared to other types of carbon black and is extremely conductive. These characteristics render acetylene black particularly interesting as electrical and/or thermal conductive agent. It is accordingly widely used e.g. in the production of batteries, fuel cells, capacitors or heating elements as well as to provide antistatic, heat dissipative or conductive properties. Additionally, acetylene blacks are utilized in some cases for imparting reinforcement and/or colouring for example to plastic or rubber articles such as tires and components thereof like tire bladders, cables, conveyor belts, rollers, hoses, floorings, or shoes, or electronic components, paints, inks coatings and adhesives.

Acetylene black is conventionally obtained as a fluffy powder with a low bulk density. Owing to the substantial absence of polar functional groups at the surface of the particles, acetylene black is moreover generally very hydrophobic and exhibits low moisture absorption. The low density fluffy form and the hydrophobic nature of acetylene black however cause difficulties when incorporating acetylene black in other materials. For instance, acetylene black often has to be finely and uniformly dispersed in a more or less polar material, such as a plastic or rubber material, or a liquid carrier medium e.g. in the manufacture of plastic or rubber articles or the preparation of an aqueous or solvent-based composition such as for the manufacture of electrodes, coatings, paints or inks. The low density fluffy form and hydrophobic nature of the acetylene black promote floating, aggregation and agglomeration of the carbon black particles, and thereby segregation of the carbon black particles from the matrix, which counteracts finely and uniformly dispersing the carbon black particles in the respective matrix and renders obtaining suitable dispersions a demanding and elaborate task. Moreover, dispersions of acetylene black tend to be not stable over time, which may give rise to undesirable variations in the properties of the final product.

Therefore, there is a continuous need for acetylene blacks that exhibit enhanced dispersibility and enable to efficiently form suitable dispersions that are stable over time, ideally without adversely affecting other properties of the acetylene black relevant for the intended application, while preserving the pulverulent form familiar to customers, allowing use of established processing and existing equipment.

Accordingly, it is an objective of the present invention to provide an acetylene black which overcomes or alleviates at least some of the above-mentioned deficiencies and limitations of the prior art. Specifically, it is an aim to provide a pulverulent acetylene black material that can be more easily and efficiently dispersed and yields high quality dispersions that are stable over extended periods of time, if possible maintaining or even improving other beneficial properties of acetylene black such as its conductivity-imparting characteristics. The acetylene black should moreover be obtainable in an economic manner compatible with conventional acetylene black production means to facilitate its implementation.

### SUMMARY OF INVENTION

This objective and additional advantages as described herein have unexpectedly been achieved by providing a process for producing a pulverulent acetylene black material as defined herein.

The present invention accordingly relates to a process for producing a pulverulent acetylene black material comprising:
providing an initial acetylene black,
densifying the provided initial acetylene black to form a densified acetylene black, and
pulverizing the densified acetylene black to form the pulverulent acetylene black material.

The present invention is also drawn to a pulverulent acetylene black material obtained by the process according to the present invention as disclosed above and described in more detail below.

The present invention furthermore relates to compositions comprising such a pulverulent acetylene black material, the preparation of such compositions and articles made therefrom, particularly electrodes or other components of energy storage and/or conversion devices as well as rubber or plastic articles.

Moreover, the present invention is directed towards the use of a pulverulent acetylene black material as disclosed herein as an electrically conductive agent, antistatic agent, thermally conductive agent, reinforcing filler and/or coloring agent, for example for a production of electrodes and other components of energy storage and/or conversion devices such as primary batteries, secondary batteries, fuel cells and capacitors, and/or of plastic articles made of a thermoplastic or thermoset polymer or rubber matrix such as tires, wire and cable sheaths, belts, hoses, shoe soles, rollers, heaters, or bladders and/or in coatings, paints or inks.

The pulverulent acetylene blacks obtained according to the process disclosed herein provide several advantages. Thus, the acetylene blacks according to the present invention exhibit enhanced dispersibility and yield dispersions that are stable over extended periods of time. Compositions with good processability including e.g. electrode pastes can be formed using the acetylene blacks according to the present invention. The acetylene blacks according to the present invention maintain or even enhance the beneficial properties of acetylene black such as its high purity and electrical conductivity and are obtainable in an economic manner compatible with conventional acetylene black production means. The acetylene blacks according to the present invention are provided in pulverulent form familiar to customers and can be used with established processing using existing equipment.

These and other optional features and advantages of the present invention will be described in more detail in the following description.

### DESCRIPTION OF THE INVENTION

As used herein, the term “comprising” is understood to be open-ended and to not exclude the presence of additional undescribed or unrecited elements, materials, ingredients or method steps etc. The terms “including”, “containing” and like terms are understood to be synonymous with “comprising”. As used herein, the term “consisting of” is understood to exclude the presence of any unspecified element, ingredient or method step etc.

As used herein, the singular form of “a”, “an”, and “the” include plural referents unless the context clearly dictates otherwise.

Unless indicated to the contrary, the numerical parameters and ranges set forth in the following specification and appended claims are approximations. Notwithstanding that the numerical ranges and parameters setting forth the broad scope of the invention are approximations, the numerical values set forth in the specific examples are reported as precisely as possible. Any numerical values, however, contain errors necessarily resulting from the standard deviation in their respective measurement.

Also, it should be understood that any numerical range recited herein is intended to include all subranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g. 1 to 6.3, or 5.5 to 10, or 2.7 to 6.1.

All parts, amounts, concentrations etc. referred to herein are by weight, unless specified otherwise.

As mentioned above, the present invention relates to a process for producing a pulverulent acetylene black material comprising providing an initial acetylene black, densifying the provided initial acetylene black to form a densified acetylene black, and pulverizing the densified acetylene black to form the pulverulent acetylene black material.

The initial acetylene black utilized as starting material for producing the pulverulent acetylene black material of the present invention can be provided in any suitable manner. The production of acetylene black is per se well known in the art and for example outlined in J.-B. Donnet et al., “Carbon Black: Science and Technology”, 2nd edition, or in Ulmanns Encyklop\ddot{a}die der technischen Chemie, 4. Edition, volume 14. The initial acetylene black may thus be produced in a reactor from a feedstock comprising acetylene, such as acetylene gas or acetylene-containing hydrocarbon feedstocks as for example described in JP A 56-90860 or U.S. Pat. No. 2,475,282. The acetylene black is typically formed by thermal decomposition of the acetylene-containing feedstock. Thermal decomposition of the acetylene-containing feedstock forming colloidal carbon black particles and hydrogen occurs at high temperatures in the reactor. The temperature for the thermal decomposition of the acetylene feedstock may for example be at least 1,500° C. such as 2,000° C.

Acetylene blacks obtainable by such acetylene black processes are commercially available from a number of manufacturers such as Orion Engineered Carbons GmbH, Denka, Hexing Chemical Industry, or Phillips Carbon Black Limited and can be utilized as starting material for producing the pulverulent acetylene black material of the present invention.

The initial acetylene black provided as starting material for producing the pulverulent acetylene black material of the present invention can have one or more than one or all of the properties described in the following:

Thus, the initial acetylene black can be characterized by its specific surface area. The initial acetylene black can for example have a BET surface area of 20 m²/g or more such as 30 m²/g or more, or 40 m²/g or more, or 50 m²/g or more, or 60 m²/g or more. The initial acetylene black can have a BET surface area of 200 m²/g or less, such as 180 m²/g or less, or 160 m²/g or less, or 140 m²/g or less, or 120 m²/g or less, or 100 m²/g or less. The BET surface area of the initial acetylene black can be in a range between any of the recited values such as from 20 m²/g to 200 m²/g, or from 40 m²/g to 140 m²/g, or from 60 m²/g to 100 m²/g. The BET surface area measured can be measured by nitrogen adsorption according to ASTM D6556-19a.

In addition or alternatively, the initial acetylene black can be characterized by its oil absorption number (OAN) measured according to ASTM D2414-19. The initial acetylene black can for example have an OAN of 500 mL/100 g or less, such as 450 mL/100 g or less, or 400 mL/100 g or less, or 350 mL/100 g or less, or 300 mL/100 g or less. The initial acetylene black can for instance have an OAN of 50 mL/100 g or more, such as 100 mL/100 g or more, or 150 mL/100 g or more, or 200 mL/100 g or more, or 250 mL/100 g or more. The OAN of the initial acetylene black can be in a range between any of the recited values such as from 50 mL/100 g to 500 mL/100 g, or from 100 mL/100 g to 400 mL/100 g, or more from 150 mL/100 g to 300 mL/100 g.

Furthermore, in addition or alternatively, the initial acetylene black can be characterized by its oil absorption number for compressed samples (COAN) as determined according to ASTM D3493-19a. The initial acetylene black can for example have a COAN of 300 mL/100 g or less such as 250 mL/100 g or less, or 200 mL/100 g or less, or 150 mL/100 g or less. The initial acetylene black can for instance have a COAN of 50 mL/100 g or more, such as 100 mL/100 g or more, or 120 mL/100 g or more, or 140 mL/100 g or more. The COAN of the initial acetylene black can be in a range between any of the recited values such as from 50 mL/100 g to 300 mL/100 g, or from 100 mL/100 g to 200 mL/100 g.

Moreover, in addition or alternatively, the initial acetylene black can be characterized by its acetone absorption number measured according to Indian Standard IS 12178-1987, test method A-6. Accordingly, the initial acetylene black can for example have an acetone absorption number of 5 mL/5 g or more such as 10 mL/5 g or more, or 15 mL/5 g or more, or 25 mL/5 g or more, or 30 mL/5 g or more. The initial acetylene black can for example have an acetone absorption number of 100 mL/5 g or less such as 80 mL/5 g or less, or 70 mL/5 g or less, or 60 mL/5 g or less, or 50 mL/5 g or less, or 40 mL/5 g or less. The initial acetylene black can have an acetone absorption number in a range between any of the recited values such as from 5 mL/5 g to 100 mL/5 g, or from 15 mL/5 g to 80 mL/5 g, or from 25 mL/5 g to 40 mL/5 g.

In addition or alternatively, the initial acetylene black can be characterized by its chemical composition or purity such as by its carbon content, sulfur content, iron content and/or ash content. For example, the initial acetylene black can have a carbon content of 90 wt. % or more, such as 95 wt. % or more, or 98 wt. % or more, preferably 99 wt. % or more, or more preferably 99.5 wt. %, based on the total weight of the initial acetylene black. The sulfur content of the initial acetylene black can for example be 1 wt. % or less such as 0.5 wt. % or less, or 0.2 wt. % or less, preferably 0.1 wt. % or less, or more preferably 0.05 wt. % or less, based on the total weight of the initial acetylene black. The carbon content and the sulfur content can be determined by quantitative elemental analysis. The initial acetylene black can have a low content of metals, particularly a low iron content. The iron content of the initial acetylene black can for example be 1000 ppm or less such as 500 ppm or less, or 200 ppm or less, or 100 ppm or less, or 50 ppm or less, or 20 ppm or less, or preferably 10 ppm or less, or more preferably 5 ppm or less, based on the total weight of the initial acetylene black. The metal content or iron content of the acetylene black can be determined by inductively coupled plasma optical emission spectroscopy (ICP-OES). Further, the initial acetylene black can have an ash content of 1 wt. % or less such as 0.5 wt. % or less, or 0.2 wt. % or less, or preferably 0.1 wt. % or less, or more preferably 0.05 wt. % or less, based on the total weight of the acetylene black. The ash content can be determined according to ASTM D1506-15.

An individual acetylene black or a mixture or combination of a plurality (two or more) acetylene blacks, e.g. having the properties as set forth above, can be employed as starting material in the process for producing the pulverulent acetylene black material of the present invention.

The initial acetylene black is typically provided in the form of a fluffy powder. The as-provided initial acetylene black may for example have a bulk density of 50 g/L or less, such as 40 g/L or less, or 35 g/L or less, or 30 g/L or less. Bulk density can be measured according to ASTM D1513-05.

As set forth above, the provided initial acetylene black is densified in the process according to the present invention to form a densified acetylene black. Densifying refers to bringing the initial acetylene black into a denser form, i.e. a form having a greater specific weight. For example, an initially provided acetylene black in the form of a fluffy powder can be densified to form compacted entities derivable therefrom such as pellets, granules or alike. Densifying may be carried out by any method known in the art for densifying pulverulent materials such as, without being limited thereto, pressing, rolling, pelletizing, granulation, briquetting or a combination thereof. Densifying the initial acetylene black can be carried out using conventional technologies and equipment including for example fluid bed spray granulation, fluidized spray drying, and agitation granulation devices such as a pin mixer or a ring layer mixer granulator, whereby a ring layer mixer granulator is preferably used according to the present invention. In a preferred practice of the present invention, densifying comprises pelletizing the initial acetylene black to form a pelleted acetylene black. In general, any method of pelletizing carbon blacks known in the art can be utilized such as dry pelletizing, wet pelletizing or a combination thereof, wherein wet pelletizing is preferred. Pelletizing of the initial acetylene black can for example be carried out as described in EP 2 913 368 B1.

In wet pelletizing initial acetylene black to be pelleted is brought into contact with a pelletizing liquid in such a manner that wet pellets are formed which may subsequently be dried. The pelletizing liquid can comprise water and/or one or more organic solvents. Advantageously, the pelletizing liquid is volatile at relatively low temperatures such as 150° C. or below facilitating drying of the wet pellets in an economic manner. Suitable organic solvents include for example alcohols, ketones, aldehydes, esters, ethers, carboxylic acids, hydrocarbons or mixtures or combinations thereof, wherein alcohols such as ethanol or isopropanol are preferred. Acids and/or bases such as hydrochloric acid, sulfuric acid, phosphoric acid or alkali hydroxides may further be used in the pelletizing liquid for adjusting pH. Pelletizing the initial acetylene black to form a pelleted acetylene black may particularly be carried out as a wet pelletizing process using an aqueous medium such as water or a mixture of water with one or more organic solvents like alcohols such as ethanol and/or isopropanol. An aqueous medium as used herein refers to a liquid medium that includes more than 50 wt. % of water, based on the total weight of the liquid medium.

For wet pelletizing, the pelletizing liquid such as an aqueous medium as set forth above can be used in an amount of 50 wt. % or more such as 60 wt. % or more, or 70 wt. % or more, or 75 wt. % or more, based on the total weight of the acetylene black and the pelletizing liquid. The pelletizing liquid can for example be used in an amount of 95 wt. % or less, such as 90 wt. % or less, or 85 wt. % or less, or 80 wt. % or less, based on the total weight of the acetylene black and the pelletizing liquid. The pelletizing liquid can be used in an amount between any of the recited values such as from 50 wt. % to 95 wt. %, or from 70 wt. % to 90 wt. %, based on the total weight of the acetylene black and the pelletizing liquid. The pelletizing liquid can be added to the acetylene black at different stages of the wet pelletizing process such as prior to or after introducing the acetylene black into, e.g., the ring layer mixer granulator.

Densifying such as (wet-)pelletizing can be carried out at elevated temperatures above ambient temperature (20° C.). For example, the densifying such as the (wet-) pelletizing can be carried out at a temperature of 30° C. or more, such as 40° C. or more, or 50° C. or more. It can for example be carried out at a temperature of 90° C. or less, such as 80° C. or less, or 70° C. or less. The densifying such as the (wet) pelletizing can be carried out in a temperature range between any of the recited temperatures, such as from 30° ° C. to 90° C., or from 40° C. to 80° C. Heating to such elevated temperature can be accomplished by heating means implemented in the apparatus used for the densification such as the ring layer mixer granulator. Additionally or alternatively, the pelletizing liquid can be heated before being mixed with the acetylene black. For example, the pelletizing liquid can be heated to a temperature as indicated above.

In the process disclosed herein, densifying the initial acetylene black can be carried out in a single densifying step or in multiple densifying steps such as in two or more densifying steps. For example, pelletizing the initial acetylene black can comprise two or more wet pelletizing steps or a combination of dry and wet pelletizing steps. The individual pelletizing steps can thereby be carried out as described hereinbefore, applying the same or different process parameters in the different densifying steps.

In the step of densifying the initial acetylene black, e.g., by dry or wet pelletizing, optionally one or more than one additive(s) may be used. Accordingly, at least one additive can be used in the step of densifying the initial acetylene black in the presence of a liquid medium and/or in a dry state. In case of wet pelletizing, the one or more additives can for example be provided together with the pelletizing liquid, e.g. as a mixture, or can be separately added to the initial acetylene black prior to and/or during the densifying treatment, e.g. before or after being introduced into an agitation granulation device. Additionally or alternatively, one or more additives can also be added to the formed densified acetylene black prior to pulverization. Suitable additives include for example dispersants and/or polymers.

A dispersant as understood herein refers to a substance aiding in dispersing the pulverulent acetylene black in a carrier medium. Dispersants as defined herein are sometimes referred to in literature also as surface-active agents, wetting agents, surfactants, or alike. Dispersants that can be used according to the present invention include any dispersants commonly used in the art including ionic, non-ionic, and amphoteric dispersants. Non-limiting examples of suitable ionic dispersants include anionic and cationic dispersants such as (poly)phosphates, silicates, citrates, polyacrylates, and carboxylates e.g. in the form of alkali metal or ammonium salts, organic phosphates such as alcohol phosphates, organic sulfates such as sodium alkyl sulfates, organic sulfonates such as sodium alkyl sulfonates, formaldehyde-naphthalene sulfonate, dioctyl ester sodium sulfosuccinic acid and sulfonated lignin, as well as trimethylhexadecyl ammonium chloride. Suitable non-ionic dispersants include organic amines such as alkanolamides like condensates of fatty acids with alkanolamines such as monoethanolamine, diethanolamine, and monoisopropanolamine, organic esters such as sorbitan laurate, sorbitan stearate, lanolin, ethoxylated octyl phenol, and phospholipids such as lecithin. Suitable non-ionic dispersants also include polymers such as polyvinylpyrrolidone, polyesters, polyethers such as glycols including polyethylene glycol (PEO), polypropylene glycol (PPO) and derivatives thereof such as reaction products of PEO and PPO with, e.g., alkanols and sorbitan stearate, as well as copolymers such as polyethylene glycol/polypropylene glycol copolymers.

Polymers that may be used as additive within the practice of the present invention are not particularly limited and include, beside the above-mentioned polymeric dispersants, all kinds of polymeric materials used in the art. Non-limiting examples include polymeric binders such as for example waxes like carnauba wax, and bee wax, colophonium resin, sugars like agarose and molasses, lignin sulfonate, celluloses such as sodium carboxymethylcellulose, and starch. Further examples include synthetic polymers and resins such as polyesters, acrylics, epoxies, melamine formaldehyde resins, phenolic resins, polyurethanes, polyamides, and vinyl esters.

The optional additive(s), if used, may be employed in any suitable amount. Typically, the one or more additives would be used in a total amount of 30 wt. % or less, such as 20 wt. % or less, or 10 wt. % or less, based on the total weight of the acetylene black and the additives. The one or more additives can for example be used in a total amount of 0.1 wt. % or more, such as 0.5 wt. % or more, or 1 wt. % or more, or 2 wt. % or more, based on the total weight of the acetylene black and the additives. The additive(s), if any, can be used in a total amount between any of the recited values such as from 0.1 wt. % to 30 wt. %, or from 1 wt. % to 10 wt. %, based on the total weight of the acetylene black and the additives. The one or more additive, if used, is preferably incorporated into the formed pulverulent acetylene black material.

The process of the present invention may optionally comprise de-aerating the initial acetylene black prior to and/or during the densifying step. By deaeration air that may be present in the material to be densified, e.g. between acetylene black particles, can be removed. De-aerating can be carried out by any method for deaeration of powders known in the art. It typically involves applying a vacuum.

The process according to the present invention can optionally further comprise drying the drying the acetylene black, for example after the densifying step and/or after the pulverization step. Drying can in particular be useful when the acetylene black is contacted with a wet medium, for instance in a wet pelleting step, to subsequently remove remainders of the wet medium such as the pelletizing liquid from the acetylene black. Drying can be carried out by drying means commonly used in the art such as by applying heat and/or a vacuum. Drying can involve exposing the acetylene black to be dried to a temperature where the wet medium to be removed such as water and/or organic solvents have a significant vapor pressure. For instance, the acetylene black to be dried can be heated to a temperature of 30° C. or more, such as 50° C. or more, or 75° C. or more, or 100° or more, or 150° C. or more. Drying can be accomplished within or by the apparatus that is also utilized for densifying such as one-pot processors or a fluidized spray granulation apparatus. Drying may also be carried out in a separate device such as in a rotary drier or oven. Drying can be carried out under a controlled atmosphere, such as in air, under an inert gas atmosphere, or under vacuum. For example, the acetylene black can be dried such that the residual moisture content of the acetylene black, e.g. densified acetylene black, after drying is less than 1 wt. %, such as less than 0.5 wt. %, or less than 0.1 wt., or less than 0.05 wt. %, based on the total weight of the acetylene black. The moisture content can be determined according to ASTM D1509-95.

By densifying the provided initial acetylene black a densified acetylene black is formed, which may optionally be dried as set forth above. The densified acetylene black accordingly has a denser form compared to the initial acetylene black. For example, the densified acetylene black can have the form of compacted entities such as pellets or granules. The densified acetylene black can for example have a bulk density of at least 100 g/L, or at least 120 g/L, or at least 140 g/L, or at least 160 g/L, or at least 180 g/L. The densified and optionally dried acetylene black can for example have a bulk density of up to 260 g/L, or up to 240 g/L, or up to 220 g/L, or up to 200 g/L. The bulk density of the densified and optionally dried acetylene black can be in a range between any of the recited values such as from 100 g/L to 260 g/L, or from 120 g/L to 220 g/L, or from 140 g/L to 200 g/L. The bulk density can be measured according to ASTM D1513-05.

The obtained densified and optionally dried acetylene black generally has a particle size distribution. The particle size distribution can vary widely. The particle size distribution can be determined by dynamic image analysis using a CAMSIZER X2 particle analyzer from Microtrac Retsch GmbH, Haan, Germany, based on ISO 13322-2.

Typically, more than 85 wt. %, such as 90 wt. % or more, or 95 wt. % or more, of the densified and optionally dried acetylene black have particle sizes in a range from 0.1 mm to 2 mm. The densified and optionally dried acetylene black may have a median particle size Dᵥ₅₀ of 0.2 mm or more, such as 0.4 mm or more, or 0.6 mm or more, or 0.8 mm or more, or 1.0 mm or more. The densified and optionally dried acetylene black may have a median particle size Dᵥ₅₀ of 2.0 mm or less, such as 1.8 mm or less, or 1.5 mm or less, or 1.2 mm or less. The median particle size Dᵥ₅₀ of the densified and optionally dried acetylene black can be in a range between any of the recited values such as in a range from 0.2 mm to 2.0 mm, or in a range from 0.4 mm to 1.8 mm, or from 0.6 mm to 1.5 mm.

The densified and optionally dried acetylene black can have a fines content according to ASTM D1508-12(2017) of 15 wt. % or less such as 10 wt. % or less, or 8 wt. % or less, or 5 wt. % or less, or 3 wt. % or less, or 1 wt. % or less, based on the total weight of the densified and optionally dried acetylene black. Optionally, the process according to the present invention can comprise a step of removing particles of selected sizes such as fines from the densified, optionally dried acetylene black. Such removing can be achieved by any respective method known in the art such as by passing through one or more screens with appropriate mesh sizes.

The densified and optionally dried acetylene black can in particular be in the form of pellets. The pellets can have an average pellet crush strength of 20 g or less such as 15 g or less, or 10 g or less, or 8 g or less. The pellets can have an average pellet crush strength of 1 g or more, such as 2 g or more, or 3 g or more, or 4 g or more, or 5 g or more. The average pellet crush strength can be in a range between any of the recited values such as from 1 g to 20 g, or from 2 g to 10 g. The average pellet crush strength can be measured by ASTM D 5230-00.

The process disclosed herein furthermore comprises pulverizing the densified optionally dried acetylene black, which can be as described above, to form the pulverulent acetylene black material according to the present invention. Pulverizing the densified acetylene black can be carried out by any means known in the art for forming a powder from compact solid entities such as pellets, granules, or solid masses, such as by milling, crushing, grinding or a combination thereof. Pulverizing such as milling the densified optionally dried acetylene black can for example be carried out using a hammer mill, jaw crusher, rotor mill, ball mill, knife mill, mortar grinder, cutting mill, discs mill, cross-beater mill, sieve assembly or a combination thereof. Pulverization according to the present invention can be carried out in one step or in multiple steps, such as in two, three or more steps, wherein the same or different pulverization means can be applied in the different pulverization steps. The densified optionally dried acetylene black is typically milled or otherwise pulverized until a free-flowing homogenous powder is formed.

The thus obtainable pulverulent acetylene black material according to the present invention can be characterized by its aggregate size distribution. The aggregate size distribution can be determined using a disc centrifuge photosedimentometer according to ISO 15825:2004. For example, the pulverulent acetylene black according to the present invention can have an aggregate size distribution with a Dᵥ₅₀ value of 50 nm or more, such as 75 nm or more, or 100 nm or more, or 200 nm or more, or 300 nm or more. The pulverulent acetylene black according to the present invention can have an aggregate size distribution with a Dᵥ₅₀ value of 1000 nm or less such as 750 nm or less, or 500 nm or less, or 400 nm or less. The pulverulent acetylene black according to the present invention can have an aggregate size distribution with a Dᵥ₅₀ value between any of the recited values such as from 50 nm to 1000 nm, or from 100 nm to 500 nm, or from 200 nm to 400 nm.

The particles of the pulverulent acetylene black material of the present invention can have an irregular or non-spherical shape. The shape can for example be characterized by an aspect ratio defined as the ratio of the minimum Feret diameter and the maximum Feret diameter. The particles of the pulverulent acetylene black of the present invention can for example have an aspect ratio of less than 0.8 such as less than 0.6, or less than 0.5, or less than 0.3. The aspect ratio can be determined from electron microscope images, averaging over at least 50 particles.

The pulverulent acetylene black material prepared according to the process according to the present invention is typically denser than the initial acetylene black from which it is produced. The pulverulent acetylene black material of the present invention can for example have a bulk density of at least 60 g/L, or at least 70 g/L, or at least 80 g/L, or at least 90 g/L, or at least 100 g/L. The pulverulent acetylene black material of the present invention can for example have a bulk density of up to 160 g/L such as up to 140 g/L, or up to 120 g/L. The bulk density of the pulverulent acetylene black material can be in a range between any of the recited values such as from 60 g/L to 160 g/L, or from 70 g/L to 140 g/L, or from 80 g/L to 120 g/L. The bulk density can be measured according to ASTM D1513-05. Without wishing to be bound to any theory, it is believed that a relatively dense pulverulent acetylene black material obtainable by the process according to the present invention optionally in combination with an irregular or non-spherical shape of the particles may promote dispersibility of the pulverulent acetylene black material and facilitate forming dispersions with favorable processing and/or application properties such as a reduced viscosity and/or enhanced electrical conductivity which are stable over extended periods of time.

The process according to the present invention may accordingly yield a pulverulent acetylene black material with improved properties such as in terms of dispersibility and processability compared to the initial acetylene black used as starting material, while other properties may remain substantially unchanged. Thus, the pulverulent acetylene black material according to the present invention can for instance have a specific surface area, OAN, COAN, acetone absorption number, ash content and/or chemical composition corresponding or comparable to the initial acetylene black. For example, the pulverulent acetylene black material according to the present invention can have a specific surface area, OAN, COAN, acetone absorption number, ash content, metal or iron content, carbon content, and/or sulfur content, which is within +30%, such as +20% or +10% of the respective property of the initial acetylene black used as a starting material for its preparation.

Thus, the pulverulent acetylene black material of the present invention can have one or more than one or all of the properties described in the following:

The pulverulent acetylene black material of the present invention can be characterized by its specific surface area. The pulverulent acetylene black material can for example have a BET surface area of 20 m²/g or more such as 30 m²/g or more, or 40 m²/g or more, or 50 m²/g or more, or 60 m²/g or more. The pulverulent acetylene black material can have a BET surface area of 200 m²/g or less, such as 180 m²/g or less, or 160 m²/g or less, or 140 m²/g or less, or 120 m²/g or less, or 100 m²/g or less. The BET surface area of the pulverulent acetylene black material can be in a range between any of the recited values such as from 20 m²/g to 200 m²/g, or from 40 m²/g to 140 m²/g, or from 60 m²/g to 100 m²/g. The BET surface area measured can be measured by nitrogen adsorption according to ASTM D6556-19a.

In addition or alternatively, the pulverulent acetylene black material can be characterized by its oil absorption number (OAN) measured according to ASTM D2414-19. The pulverulent acetylene black material can for example have an OAN of 500 mL/100 g or less, such as 450 mL/100 g or less, or 400 mL/100 g or less, or 350 mL/100 g or less, or 300 mL/100 g or less. The pulverulent acetylene black material can for instance have an OAN of 50 mL/100 g or more, such as 100 mL/100 g or more, or 150 mL/100 g or more, or 200 mL/100 g or more, or 250 mL/100 g or more. The OAN of the pulverulent acetylene black material can be in a range between any of the recited values such as from 50 mL/100 g to 500 mL/100 g, or from 100 mL/100 g to 400 mL/100 g, or more from 150 mL/100 g to 300 mL/100 g.

Furthermore, in addition or alternatively, the pulverulent acetylene black material can be characterized by its oil absorption number for compressed samples (COAN) as determined according to ASTM D3493-19a. The pulverulent acetylene black material can for example have a COAN of 300 mL/100 g or less such as 250 mL/100 g or less, or 200 mL/100 g or less, or 150 mL/100 g or less. The pulverulent acetylene black material can for instance have a COAN of 50 mL/100 g or more, such as 100 mL/100 g or more, or 120 mL/100 g or more, or 140 mL/100 g or more. The COAN of the pulverulent acetylene black material can be in a range between any of the recited values such as from 50 mL/100 g to 300 mL/100 g, or from 100 mL/100 g to 200 mL/100 g.

Moreover, in addition or alternatively, the pulverulent acetylene black material can be characterized by its acetone absorption number measured according to Indian Standard IS 12178-1987, test method A-6. Accordingly, the pulverulent acetylene black material can for example have an acetone absorption number of 5 mL/5 g or more such as 10 mL/5 g or more, or 15 mL/5 g or more, or 25 mL/5 g or more, or 30 mL/5 g or more. The pulverulent acetylene black material can for example have an acetone absorption number of or 100 mL/5 g or less such as 80 mL/5 g or less, or 70 mL/5 g or less, or 60 mL/5 g or less, or 50 mL/5 g or less, or 40 mL/5 g or less. The pulverulent acetylene black material can have an acetone absorption number in a range between any of the recited values such as from 5 mL/5 g to 100 mL/5 g, or from 15 mL/5 g to 80 mL/5 g, or from 25 mL/5 g to 40 mL/5 g.

In addition or alternatively, the pulverulent acetylene black material can be characterized by its chemical composition or purity such as by its carbon content, sulfur content, iron content, and/or ash content. For example, the pulverulent acetylene black material can have a carbon content of 90 wt. % or more, such as 95 wt. % or more, or 98 wt. % or more, or preferably 99 wt. % or more, or more preferably 99.5 wt. % or more, based on the total weight of the pulverulent acetylene black material. The sulfur content of the pulverulent acetylene black material can for example be 1 wt. % or less such as 0.5 wt. % or less, or 0.2 wt. % or less, or preferably 0.1 wt. % or less, or more preferably 0.05 wt. % or less, based on the total weight of the pulverulent acetylene black material. The carbon content and the sulfur content can be determined by quantitative elemental analysis. The pulverulent acetylene black material can have a low content of metals, particularly a low iron content. The iron content of the pulverulent acetylene black material can for example be 1000 ppm or less such as 500 ppm or less, or 200 ppm or less, or 100 ppm or less, or 50 ppm or less, or 20 ppm or less, or preferably 10 ppm or less, or more preferably 5 ppm or less, based on the total weight of the pulverulent acetylene black material. The metal content or iron content of the pulverulent acetylene black material can be determined by inductively coupled plasma optical emission spectroscopy (ICP-OES). Further, the pulverulent acetylene black material can have an ash content of 1 wt. % or less such as 0.5 wt. % or less, or 0.2 wt. % or less, or preferably 0.1 wt. % or less, or more preferably 0.05 wt. % or less, based on the total weight of the pulverulent acetylene black material. The ash content can be determined according to ASTM D1506-15.

The process according to the present invention thus allows to prepare a pulverulent acetylene black material with unique properties uncoupled from the actual production of acetylene black from an acetylene-containing feedstock in a reactor, while retaining certain characteristics of conventional acetylene black grades, rendering substitution of these grades by the pulverulent acetylene black material of the present invention more amenable to customers.

The pulverulent acetylene black material can advantageously be processed using common powder processing means and can be readily used in formulating compositions. The present invention thus also concerns compositions comprising the pulverulent acetylene black material described hereinbefore. Such compositions typically comprise a dispersion of the pulverulent acetylene black in a carrier medium. As described above, an advantage of the pulverulent acetylene black according to the present invention resides in its good dispersibility in carrier media, remarkable stability, and good processing and application properties of the resulting dispersions. Suitable carrier media include aqueous or organic solvent-based carrier media or plastic matrices.

As used herein an aqueous carrier medium refers to a carrier medium that includes more than 50 wt. %, such as 70 wt. % or more, or 80 wt. % or more, or 90 wt. % or more, or up to 100 wt. %, of water, based on the total weight of the carrier medium. An organic solvent-based carrier medium refers to a carrier medium that includes more than 50 wt. %, such as 70 wt. % or more, or 80 wt. % or more, or 90 wt. % or more, or up to 100 wt. %, of organic solvent(s), based on the total weight of the carrier medium. The kind of carrier medium used depends on the respective type of application and may vary widely. The carrier medium may comprise water and/or one or more organic solvent(s). Organic solvents that may be used include for example, without being limited thereto alcohols, ketones, aldehydes, amines, esters, ethers, carboxylic acids, hydrocarbons, or mixtures or combinations thereof.

Similarly, all types of polymer or resin materials can be used as plastic matrices in compositions according to the present invention, depending on the intended application. Non-limiting examples of useful resins and polymers that can be employed according to the present invention include olefinic polymers such as polypropylene, polyethylene, ethylene-vinyl acetate copolymers, ethylene-vinyl alcohol resins, cyclic olefin copolymers, rubbers such as natural rubber, styrene butadiene rubber, acrylonitrile butadiene rubber, butyl rubber, acryl rubber, ethylene-propylene rubber, ethylene-propylene terpolymer, ethylene-α-olefin copolymer rubber, silicone rubber, fluoro rubber, chloroprene rubber, hydrin rubber, and chlorosulfonated polyethylene rubber, vinyl chloride-type polymers such as polyvinyl chloride and ethylene vinyl chloride copolymers, styrene-type polymers such as polystyrene, styrene-acrylonitrile copolymers and acrylonitrile-butadiene-styrene copolymers, acrylic polymers such as polymethyl methacrylate, polyesters such as polyethylene terephthalate, polybutylene terephthalate, polyamides, polyacetales, polycarbonates, polyphenylene ethers, fluoropolymers such as polytetrafluoroethylene and polyvinylidine fluoride, polyphenyline sulfides, liquid crystal polymers, thermoplastic polyamides, ketone-type resins, sulfonic resins, phenyl resins, urea resins, melamine resins, alkyd resins, silicone resins, epoxy resins, urethane resins, polyvinyl esters, polyimides, furan resins, quinine resins, as well as mixtures, blends or combinations thereof.

Depending on the type of application, further ingredients can be used in formulating the compositions according to the present invention. The skilled artisan will select such optional further ingredients and their respective amounts in accordance with the desired properties and/or application of the composition. Illustrative examples of such further ingredients include for instance oils and waxes, processing aids, rheology modifiers, pH modifiers, fillers, pigments, dyes, coupling agents, catalysts, accelerators, vulcanizing agents, activators, sulfur curatives, antidegradants, antioxidants, stabilizers, biocides, and plasticizers. As described in more detail below, the compositions according to the present invention are for instance useful for electrochemical applications like battery applications. For these applications they may accordingly further comprise one or more electrochemically active ingredient. The electrochemically active ingredient can for instance be a common anode material or cathode material.

The compositions according to the present invention can be prepared by a process comprising dispersing the pulverulent acetylene black material as disclosed herein in a carrier medium, such as an aqueous or organic solvent-based carrier medium or a plastic material as described above. Optional further ingredients, such as described above, if any, can be added with the pulverulent acetylene black material or separately therefrom. The resulting mixture may optionally be dried and/or cured.

The pulverulent acetylene black material according to the present invention can be compounded and dispersed in the carrier medium, such as an aqueous or organic solvent-based carrier medium or a plastic material as described above, using common mixing and blending equipment e.g., blenders, mixers, kneaders, single- or twin-screw extruders. The amounts in which the pulverulent acetylene black material is used depend significantly on the type of composition and intended application and will be selected by the skilled artisan according to the respective needs based on similar formulations with conventional acetylene blacks.

As will be appreciated, the compositions according to the invention can be utilized in various technical applications, particularly where acetylene blacks are generally appreciated for their characteristics such as electrical and/or thermal conductivity and where good dispersibility and the formation of stable dispersions with good processing properties are desired or beneficial.

The pulverulent acetylene black material of the present invention can for example impart electrical conductivity to compositions containing the same and articles manufactured therefrom. Thus, the pulverulent acetylene carbon black material of the present invention is particularly useful for instance for battery applications, including primary batteries, secondary batteries, fuel cells or capacitors. Accordingly, the present invention is also directed towards an electrode or other component of an energy storage and/or conversion device made from a composition comprising the pulverulent acetylene black material disclosed herein.

Furthermore, the pulverulent acetylene black material may also be used as an antistatic agent or as an electrically conductive agent, for instance in plastic materials and articles. Furthermore, the pulverulent acetylene black material of the present invention can be used to impart electrical and/or thermal conductivity to polymer and rubber compounds such as bladders for the production of tires. The present invention thus also provides a rubber or plastic article made from a composition comprising the pulverulent acetylene black material disclosed herein.

Accordingly, the pulverulent acetylene black of the present invention can for example be advantageously used as an electrically conductive agent, antistatic agent, thermally conductive agent, reinforcing filler and/or coloring agent for a production of electrodes and other components of energy storage and/or conversion devices such as primary batteries, secondary batteries, fuel cells and capacitors, and/or of plastic articles made of a thermoplastic or thermoset polymer or rubber matrix such as tires, wire and cable sheaths, belts, hoses, shoe soles, rollers, heaters, or bladders and/or in coatings, paints or inks.

Having generally described the present invention above, a further understanding can be obtained by reference to the following specific examples. These examples are provided herein for purposes of illustration only, and are not intended to limit the present invention, which is rather to be given the full scope of the appended claims including any equivalents thereof.

### EXAMPLES

All parts and percentages indicated throughout the Examples are based on weight, unless specified otherwise.

### Applied Methods for the Characterization of Acetylene Blacks

The BET specific surface area was measured by nitrogen adsorption in accordance with ASTM D6556-19a.

The oil absorption number (OAN) was measured according to ASTM D2414-19.

The oil absorption number for compressed samples (COAN) was determined according to ASTM D3493-19a.

The carbon content and sulfur content were determined by quantitative elemental analysis using an automated elemental analyser (vario EL cube elemental analyser from Elementar Analysensysteme GmbH) following DIN 51732-2014-07.

The total metal content including the iron content was determined by ICP-OES using a Prodigy 7 instrument from TELEDYNE LEEMAN LABS, Mason, USA.

The ash content was measured according to ASTM D1506-15.

The moisture content was measured according to ASTM D1509-95.

The bulk density was measured according to ASTM D1513-05.

### Acetylene Black Materials

An acetylene black (referred to herein as Acetylene Black A), commercially available from Orion Engineered Carbon GmbH having the properties as set forth in Table 1 below, was used as starting material for preparing densified or pulverulent acetylene black materials as described hereinbelow and served as reference material.

TABLE 1
Properties of starting material

| | | Acetylene Black A |
|---|---|---|
| OAN | [mL/100 g] | 320 |
| COAN | [mL/100 g] | 140 |
| BET specific surface area | [m²/g] | 67 |
| Carbon content | [%] | 99 |
| Sulphur content | [%] | 0.01 |
| Iron content | [ppm] | <5 |
| Total metal content | [%] | 0.002 |
| Ash content | [%] | <0.025 |
| Moisture content | [%] | <0.05 |
| Bulk density | [g/L] | approx. 50 |

Preparation of pelleted acetylene black material (Acetylene Black B)

The carbon black starting material was pelleted utilizing a heated ring layer mixer granulator RMG 300 available from amixon GmbH (Paderborn, Germany) equipped with a rotating mixer shaft with pins. The starting material was continuously fed at a rate of 70-75 kg/h by a gravimetric feeding device into the granulator. Demineralized water having a temperature of less than 70° C. was continuously injected through a pressurized spray nozzle at a rate of 180 L/h. The rotating mixing shaft of the granulator was rotated at a speed of 350 rpm, the temperature of the RMG 300 was set to more than 32° C. and less than 75° C.

The obtained pelleted material was then dried in a natural gas fired rotary drier having a combustion chamber temperature of >550° C. and a carbon black bed temperature at the exit of the drier of less than 150° C.

Selected properties of the thus obtained dried pelleted acetylene black material (referred to as Acetylene Black B) are summarized in Table 2 below.

Preparation of Pulverulent Acetylene Black Material According to the Invention (Acetylene Black C) from the Pelleted Acetylene Black (Acetylene Black B)

The pelleted acetylene black B was subjected to milling to produce a pulverulent acetylene black according to the present invention (referred to as Acetylene Black C). The milling was executed in a cross-beater mill of the type “Pulverisette 1” from Fritsch GmbH, Idar-Oberstein, Germany applying 2850 rpm and a stainless-steel screen size of 0.25 mm.

Selected properties of the thus obtained pulverized acetylene black material (referred to as Acetylene Black C) are also summarized in Table 2 below.

TABLE 2
Properties of dried pelleted and pulverized acetylene black material

| | | Acetylene | Acetylene |
|---|---|---|---|
| | | Black B | Black C |
| OAN | [mL/100 g] | 265 | 250 |
| COAN | [mL/100 g] | 140 | |
| BET specific | [m²/g] | 70 | 70 |
| surface area | | | |
| Sulphur content | [%] | 0.01 | 0.01 |
| Iron content | [ppm] | <5 | <5 |
| Ash content | [%] | <0.025 | <0.025 |
| Moisture content | [%] | <0.05 | <0.05 |
| Bulk density | [g/L] | approx. 200 | >100 |

From Table 2 in comparison to Table 1 it can be seen that the properties of the acetylene black starting material can be mostly retained by the preparation process of the present invention, while yielding a pulverulent acetylene black material of higher density compared to the acetylene black starting material.

### Preparation of Electrode Formulations Using Acetylene Blacks A-C

A dry premix was prepared by adding 3.5 g Solef 5130 (Solvay) PVDF polymer, 93 g Lithium-Nickel-Manganese-Cobalt-Oxide NMC 532 (BASF), and 3.5 g of the respective acetylene black material (Acetylene Black A, B, or C, cf. Table 3 below) to the mixing vessel of a double-planetary mixer of the type FMPE HM2P-03 from Bühler Technologies GmbH, Ratingen, Germany. The composition was mixed for 4 min in the double-planetary mixer at a speed of 20 rpm at room temperature.

Next, the premix was dispersed in an organic solvent in a two-step procedure. At first, 40 g N-Methyl-2-pyrrolidon (NMP, analytical purity ≥99.5% provided by VWR chemicals) were added to 100 g of the respective premix and then mixed in the double-planetary mixer for 10 min at 40 rpm followed by 20 min at 60 rpm. Subsequently, additional 5 g NMP were added to the mixture and the composition mixed for another 20 min at 60 rpm in the double-planetary mixer to obtain an electrode paste.

The resulting electrode pastes were assessed in terms of their viscosity using a rheometer MCR302 from Anton Paar, Ostfildern-Scharnhausen, Germany. The viscosities were measured by running shear rate from 0 to 500 s⁻¹ at 20° C. and the gap of plate-to-plate was 0.5 mm. The viscosities at a shear rate of 200 s⁻¹ are reported in Table 3 below.

### Preparation of Electrode Films and Measurement of Electrical Resistivity

Electrode films were prepared from the prepared electrode pastes (a) as freshly prepared, (b) after standing for 3 hours, and (c) after standing for 24 hours. Cathode films were prepared according to the following procedure: A 20 μm thick aluminum foil was applied on a coater (K control coater from TQC Sheen). The respective electrode paste without any bubbles was then applied onto the aluminum foil and the thickness of the layer was adjusted using a doctor blade. The coated electrodes were dried for 3 hours at 100° C. in the vacuum oven. Film thickness of the resulting electrode layer was each 50 μm. The electrical resistance of the obtained coated electrodes was measured with an RM 3543 resistance HiTESTER from HIOKI using coin cell samples punched from the dried coating on Al foil. An average value of conductivity was calculated from 6 coins at diameter of 1.4 mm from the same coating and reported below in Table 3.

TABLE 3

| | Example 1 | Example 2 | |
|---|---|---|---|
| | (Comparative | (Comparative | |
| Parameter | Example) | Example) | Example 3 |
| Acetylene Black | Acetylene | Acetylene | Acetylene |
| material | Black A | Black B | Black C |
| Paste viscosity at | 2872 | 3104 | 2702 |
| 200/s [mPa · s] | | | |
| Electrode resistivity | | | |
| [Ω · cm] | | | |
| with freshly | 71 | 90.3 | 59 |
| prepared | | | |
| paste | | | |
| after | 77 | 86.9 | 59 |
| standing for | | | |
| 3 h | | | |
| after | 86 | 91 | 60 |
| standing for | | | |
| 24 h | | | |

As it can be seen from Table 3, the paste formed using the acetylene black material according to the present invention (Example 3) exhibited a reduced viscosity compared to the pastes containing the commercial reference material (Comparative Example 1) or derived from the pelleted acetylene black (Comparative Example 2), which is indicative of a better dispersion of the acetylene black according to the present invention in the electrode paste and of favorable processing properties. Further, the electrode films obtained from the pulverulent acetylene black material according to the present invention (Example 3) exhibited a significantly lower electrical resistivity than those derived from the commercial reference material (Comparative Example 1) or derived from the pelleted acetylene black (Comparative Example 2). The obtained electrode resistivity was stable, and in contrast to the Comparative Examples did not significantly increase upon storage of the electrode paste for times up to 24 hours, indicative of enhanced stability of the dispersion formed using the pulverulent acetylene black material according to the present invention.

1. A process for producing a pulverulent acetylene black material comprising:
providing an initial acetylene black,
densifying the provided initial acetylene black to form a densified acetylene black, and
pulverizing the densified acetylene black to form the pulverulent acetylene black material.

2. The process according to claim 1, wherein densifying the initial acetylene black comprises pelletizing the initial acetylene black to form a pelleted acetylene black.

3. The process according to claim 1, comprising using at least one additive in the step of densifying the initial acetylene black in the presence of a liquid medium and/or in a dry state.

4. The process according to claim 1, wherein the densifying step is conducted using an agitation granulation device.

5. The process according to aa claim 1, wherein the densified acetylene black has a bulk density measured according to ASTM D1513-05 of at least 100 g/L.

6. The process according to claim 1, wherein pulverizing the densified acetylene black comprises milling the densified acetylene black.

7. The process according to claim 1, wherein the process further comprises de-aerating the initial acetylene black prior to the densifying step and/or wherein the process further comprises drying the acetylene black.

8. A pulverulent acetylene black material obtained according to the process of claim 1.

9. The pulverulent acetylene black material according to claim 8 having a bulk density measured according to ASTM D1513-05 of at least 60 g/L.

10. The pulverulent acetylene black material according to claim 8 having one or more than one or all of the following:
a BET surface area measured according to ASTM D6556-19a of 20 to 200 m²/g,
an oil absorption number (OAN) measured according to ASTM D2414-19 of 100 to 500 mL/100 g,
an acetone absorption number measured according to Indian Standard IS 12178-1987, test method A-6, of 15 to 80 mL/5 g,
a carbon content of at least 99.0 wt. %,
a sulfur content of less than 0.1 wt. %,
an iron content of less than 1,000 ppm, and/or
an ash content measured according to ASTM D1506-15 of less than 0.1 wt. %.

11. A composition comprising a pulverulent acetylene black material according to claim 8.

12. The composition according to claim 11 further comprising at least one electrochemically active ingredient.

13. An article made from the composition according to claim 11, wherein the article is selected from the group consisting of an electrode or other component of an energy storage device or of an energy conversion device, a rubber article, and a plastic article.

14. (canceled)

15. An article comprising the pulverulent acetylene black material according to claim 8, wherein the article is selected from the group consisting of electrodes and other components of energy storage and/or conversion devices, primary batteries, secondary batteries, fuel cells and capacitors, plastic articles made of a thermoplastic or thermoset polymer or rubber matrix, tires, wire and cable sheaths, belts, hoses, shoe soles, rollers, heaters, or bladders and/or in-coatings, paints or inks.

16. The process according to claim 2, wherein the initial acetylene black is wet pelletized using an aqueous medium.

17. The process according to claim 3, wherein the additive comprises a dispersant or a polymer.

18. The process according to claim 7, wherein the drying step is practiced after the densifying step and residual moisture content is less than 0.5 wt. %.

19. The composition of claim 11, wherein the composition comprises a dispersion of the pulverulent acetylene black material in an aqueous medium, an organic solvent-based carrier medium, or a plastic matrix.
